(19) United States
(12) Patent Application Publication
(10) Pub. No.: US 2008/0282161 A1
(43) Pub. Date: Nov. 13, 2008

(54) MASKING CHANGES TO A COMPUTER APPLICATION

(76) Inventors: Donna N. Dillenberger, Yorktown Heights, NY (US); Radha Ratnaparkhi, Ridgefield, CT (US)

Correspondence Address: HOFFMAN WARNICK LLC, 75 STATE ST, 14TH FLOOR, ALBANY, NY, 12207, US

(21) Appl. No.: 11/747,088

(22) Filed: May 10, 2007

(51) Int. Cl. G06F 3/048

(52) U.S. Cl. 715/706

(57) ABSTRACT

The present invention provides an interface (as well as associated methods, systems, program products, etc.) for masking changes to a computer application. In general, the interface comprises a facade for facilitating interaction between the interface and a user; a dialog wizard for receiving a set of instructions for the computer application from the user pursuant to an interaction between the user and the facade; and a set of workflows linking the interface with the computer application, the set of workflows being configured to interpret the set of instructions and to direct a behavior of the application based on the interpretation. That is, the set of workflows are configured to convert the set of instructions into a set of commands that are understood by the computer application.

### FIELD OF THE INVENTION

The present invention generally relates to computer applications. Specifically, the present invention provides an interface for masking changes of a computer application from a user.

### BACKGROUND OF THE INVENTION

Businesses currently use computer applications to track and manage resources, for example: inventory management, employee population, salary plans, system changes, project management, etc. These computer applications typically have a span of one month to a few years. When the applications change, the business forces its population to learn the new interfaces and systems. This imposes costs in terms of time to learn new systems and interfaces, specialists to help answer questions and fix errors and a rollout plan to transition employees from the old application to the new application.

Currently, an approach does not exist that prevents such costs. As such, there is a need for a solution that addresses this issue.

### SUMMARY OF THE INVENTION

In general, the present invention provides an interface (as well as associated methods, systems, program products, etc.) for masking changes to a computer application. In general, the interface comprises a facade for facilitating interaction between the interface and a user; a dialog wizard for receiving a set of instructions for the computer application from the user pursuant to an interaction between the user and the facade; and a set of workflows linking the interface with the computer application, the set of workflows being configured to interpret the set of instructions and to direct a behavior of the application based on the interpretation. That is, the set of workflows are configured to convert the set of instructions into a set of commands that are understood by the computer application.

Along these lines, the facade can comprise a 3-dimensional avatar, the interaction being between the user and the 3-dimensional avatar. The facade can also comprise a voice recognition program, the set of instructions being received verbally from the user. Still yet, the facade can comprise a set of natural language scripts, the set of instruction being received typographically from the user. Under the present invention, the set of instructions can be independent of a programming of the computer application, thus, preventing the user from having to be educated on the operation of the computer application and/or any subsequent changes thereto. In a typical embodiment, the interface is created via a set of libraries that provides (among other things) a mapping of instructions to behaviors of the computer application.

A first aspect of the present invention provides an interface for masking changes to a computer application, comprising: a facade for facilitating interaction between the interface and a user; a dialog wizard for receiving a set of instructions for the computer application from the user pursuant to an interaction between the user and the facade; and a set of workflows linking the interface with the computer application, the set of workflows being configured to interpret the set of instructions and to direct a behavior of the application based on the interpretation.

A second aspect of the present invention provides a method for masking changes to a computer application, comprising: receiving a set of instructions for the computer application from a user, the set of instructions being in a format independent of a programming of the computer application; interpreting the set of instructions; converting the set of instructions into a set of commands that are understood by the computer application; and directing a behavior of the application based on the set of commands.

A third aspect of the present invention provides a program product stored on a computer readable medium for masking changes to a computer application, the computer readable medium comprising program code for enabling a computer system to: receive a set of instructions for the computer application from a user, the set of instructions being in a format independent of a programming of the computer application; interpret the set of instructions; convert the set of instructions into a set of commands that are understood by the computer application; and direct a behavior of the application based on the set of commands.

A fourth aspect of the present invention provides a system for masking changes to a computer application, comprising: a module for receiving a set of instructions for the computer application from a user, the set of instructions being in a format independent of a programming of the computer application; a module for interpreting the set of instruction; a module for converting the set of instructions into a set of commands that are understood by the computer application; and a module for directing a behavior of the application based on the set of commands.

A fifth aspect of the present invention provides a method for deploying a system for masking changes to a computer application, comprising: providing a computer infrastructure being configured to: receive a set of instructions for the computer application from a user, the set of instructions being in a format independent of a programming of the computer application; interpret the set of instructions; convert the set of instructions into a set of commands that are understood by the computer application; and direct a behavior of the application based on the set of commands.

A sixth aspect of the present invention provides a data processing system for masking changes to a computer application, comprising a memory medium having program code; a bus coupled to the memory medium; a processor coupled to the bus that when executing the program code causes the data processing system to: receive a set of instructions for the computer application from a user, the set of instructions being in a format independent of a programming of the computer application; interpret the set of instructions; convert the set of instructions into a set of commands that are understood by the computer application; and direct a behavior of the application based on the set of commands.

A seventh aspect of the present invention provides a computer-implemented business method for masking changes to a computer application, comprising: receiving a set of instructions for the computer application from a user, the set of instructions being in a format independent of a programming of the computer application; interpreting the set of instructions; converting the set of instructions into a set of commands that are understood by the computer application; and directing a behavior of the application based on the set of commands.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an interface for masking changes to a computer application according to an aspect of the present invention.

FIG. 2 depicts a more specific computerized implementation of the interface of FIG. 1 according to an aspect of the present invention

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description

II. Computerized Implementation

### I. General Description

As indicated above, the present invention provides an interface (as well as associated methods, systems, program products, etc.) for masking changes to a computer application. In general, the interface comprises a facade for facilitating interaction between the interface and a user; a dialog wizard for receiving a set of instructions for the computer application from the user pursuant to an interaction between the user and the facade; and a set of workflows linking the interface with the computer application, the set of workflows being configured to interpret the set of instructions and to direct a behavior of the application based on the interpretation. That is, the set of workflows are configured to convert the set of instructions into a set of commands that are understood by the computer application.

Along these lines, the facade can comprise a 3-dimensional avatar, the interaction being between the user and the 3-dimensional avatar. The facade can also comprise a voice recognition program, the set of instructions being received verbally from the user. Still yet, the facade can comprise a set of natural language scripts, the set of instruction being received typographically from the user. Under the present invention, the set of instructions can be independent of a programming of the computer application, thus, preventing the user from having to be educated on the operation of the computer application and/or any subsequent changes thereto. In a typical embodiment, the interface is created via a set of libraries that provides (among other things) a mapping of instructions to behaviors of the computer application.

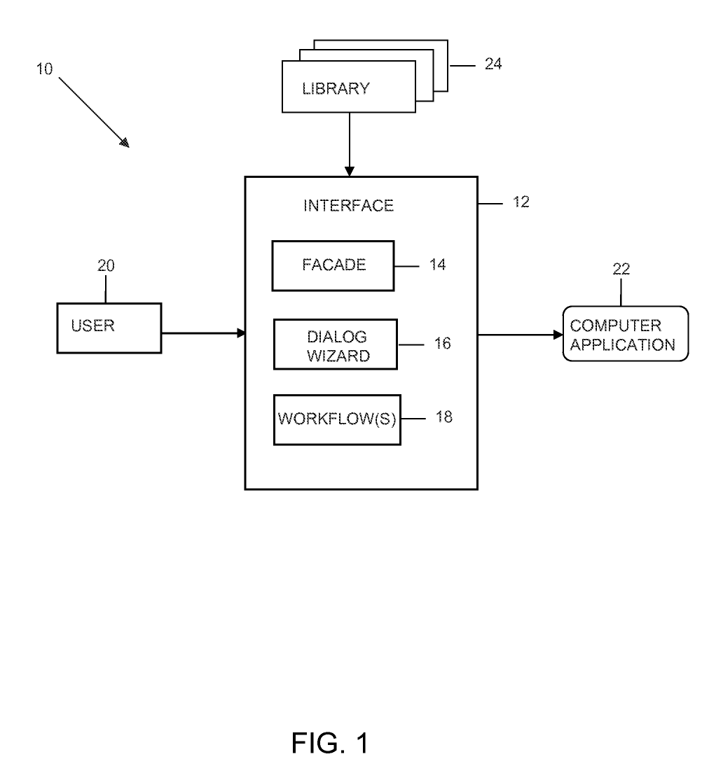

Referring now to FIG. 1, a system 10 for masking changes to a computer application (hereinafter application 22) according to the present invention is shown. Specifically, system 10 includes an interface 12 that links user 20 with application 20. As indicated above, whenever application 22 changes, users such as user 20 historically would have to be trained on the operation and programming of the new or updated application 22. Interface 12 prevents such a need. Specifically, interface 12 is configured to receive a set (at least one) of instructions from user 20. The set of instructions can be issued by user 20 in a natural language or at the very least a format that can be independent of a programming of application 22. As such, user 20 need not be educated on the operation, format, and/or programming of application 22. Therefore, the inner workings/functioning/programming of application 22 or any changes to application 22 can be masked from user 20.

In general, interface 12 is created via a set of libraries 24 that (among other things) provides a mapping of instructions to behaviors of the computer application. As shown, interface 12 includes a facade 14 for facilitating interaction between 12 interface and user 20, a dialog wizard 16 for receiving a set of instructions for application 16 from user 20 pursuant to an interaction between user 20 and facade 14, and a set of workflows 18 linking interface 12 with application 22.

Along these lines, facade 14 can comprise (among other things): a 3-dimensional avatar so that the set of instructions being received pursuant to an interaction between the user and the 3-dimensional avatar; a voice recognition program whereby the set of instructions are received verbally from the user, and/or a set of natural language scripts whereby the set of instruction being received typographically from the user. Dialog wizard 16 can comprise program(s) used to simulate an “intelligent” conversation with user 20 that is context sensitive. Set of workflows 18 are program(s) that are behind facade 14 and that user 20 invokes to get information or perform a task, without having to know the syntax, or system commands required by application 22 for the query or task. As such, the set of instructions can be independent of a programming of application 22.

Typically, set of workflows 18 are configured to convert the set of instructions into a set of commands that are understood by the computer application, and then direct a behavior of application 22 based on the set of commands. For example, assume that application 22 is an inventory management application. Further assume that user 20 wishes to add a new product to an inventory using application 22. Prior to the present invention, user 20 would have to be educated on the operation and proper programming/instructing/syntax of application 22. Now, user 20 can submit a request/task to add the product to the inventory using his/her own natural language. Interface is configured to take that instruction from user 20 and convert it into one or more commands that are understood by, recognized by, and/or in the format of application 22. Thereby, obviating the need for user 20 to be educated on the syntax, programming, format, etc. of application 22.

### II. Computerized Implementation

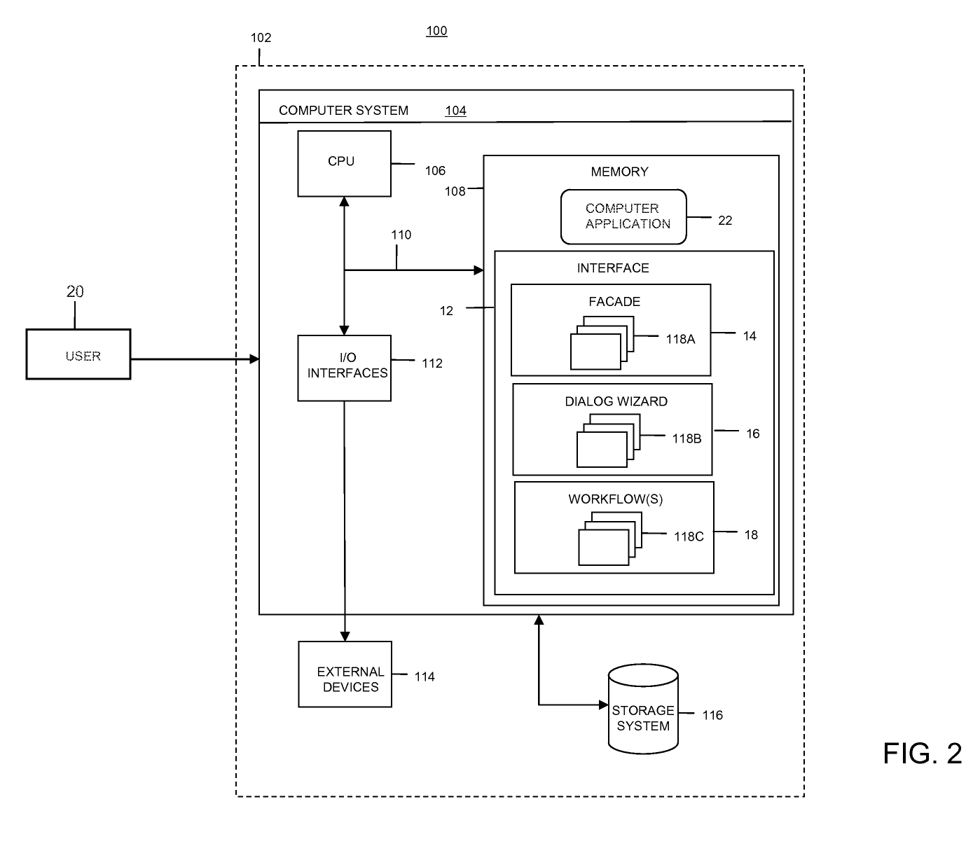

Referring now to FIG. 2, a computerized implementation 100 of the present invention is shown. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, such as interface 12 and application 22, which are stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enables computer system 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, I/O interfaces 112 can comprise any module for exchanging information with one or more external device 114. Still further, it is understood that one or more additional components (e.g., system software, math co-processing unit, etc.) not shown in FIG. 2 can be included in computer system 104. However, if computer system 104 comprises a handheld device or the like, it is understood that one or more external devices 114 (e.g., a display) and/or storage system 116 could be contained within computer system 104, not externally as shown. In addition, it should be understood that interface 12 and application 22 need not be stored/loaded on the same computer system 104. That is, they could be loaded on two or more separate computer systems that communicate over a network, and that may or may not be part of a common infrastructure 102.

Storage system 116 can be any type of system (e.g., a database) capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 are interface 12 and application 22. Interface 12 includes facade 14, dialog wizard 16, and set of workflow 18. Each of these components typically includes one or more systems/programs/modules 118A-C that provides the functionality of the present invention. It should be understood that a certain configuration of components, modules/systems, etc. have been depicted in FIG. 2 for illustrative purposes only and similar or identical functionality could be accomplished with a different configuration.

As indicated above, facade 14 As shown, interface 12 includes a facade 14 for facilitating (e.g., avatar, voice recognition program(s), natural language script(s), etc.) interaction between 12 interface and user 20, a dialog wizard 16 for receiving a set of instructions for application 16 from user 20 pursuant to an interaction between user 20 and facade 14, and a set of workflows 18 that link interface 12 with application 22 and that interpret the set of instructions and direct a behavior of application 22 based thereon. Specifically, the module(s) 118C of set of workflows are configured to convert (among other things) the set of instructions into a set of commands that are understood by the computer application, and then direct a behavior of application 22 based on/using the set of commands. As such, the set of instructions can be in a format that is independent of a programming of application 22.

While shown and described herein as an interface for masking changes to a computer application, it is understood that the invention further provides various alternative embodiments. For example, in one embodiment, the invention provides a computer-readable/useable medium that includes computer program code to enable a computer infrastructure to mask changes to a computer application. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 2) and/or storage system 116 (FIG. 2) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to mask changes to a computer application. In this case, the service provider can create, maintain, support, etc., a computer infrastructure, such as computer infrastructure 102 (FIG. 2) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for to masking changes to a computer application. In this case, a computer infrastructure, such as computer infrastructure 102 (FIG. 2), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104 (FIG. 2), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. An interface for masking changes to a computer application, comprising:
a facade for facilitating interaction between the interface and a user;
a dialog wizard for receiving a set of instructions for the computer application from the user pursuant to an interaction between the user and the facade; and
a set of workflows linking the interface with the computer application, the set of workflows being configured to interpret the set of instructions and to direct a behavior of the application based on the interpretation.

2. The interface of claim 1, the facade comprising a 3-dimensional avatar, the interaction being between the user and the 3-dimensional avatar.

3. The interface of claim 1, the facade comprising a voice recognition program, the set of instructions being received verbally from the user.

4. The interface of claim 1, the facade comprising a set of natural language scripts, the set of instruction being received typographically from the user.

5. The interface of claim 1, the set of instructions being independent of a programming of the computer application.

6. The interface of claim 1, the facade, the set of workflows, and the dialog wizard being created via a set of libraries.

7. The interface of claim 6, the set of libraries providing a mapping of instructions to behaviors of the computer application.

8. The interface of claim 6, the set of workflows being configured to convert the set of instructions into a set of commands that are understood by the computer application.

9. A method for masking changes to a computer application, comprising:
receiving a set of instructions for the computer application from a user, the set of instructions being in a format independent of a programming of the computer application;
interpreting the set of instructions;
converting the set of instructions into a set of commands that are understood by the computer application; and
directing a behavior of the application based on the set of commands.

10. The method of claim 9, the set of instructions being received via a dialog wizard of an interface to the computer application, and the set of instructions further being received pursuant to an interaction between the user and a facade of the interface.

11. The method of claim 10, the facade comprising a 3-dimensional avatar, the interaction being between the user and the 3-dimensional avatar.

12. The method of claim 10, the facade comprising a voice recognition program, the receiving comprising receiving the set of instructions verbally from the user.

13. The method of claim 10, the facade comprising a set of natural language scripts, the receiving comprising receiving the set of instructions typographically from the user.

14. The method of claim 9, further comprising providing a set of libraries for the method.

15. The method of claim 14, the set of libraries providing a mapping of instructions to behaviors of the computer application.

16. A program product stored on a computer readable medium for masking changes to a computer application, the computer readable medium comprising program code for enabling a computer system to:
receive a set of instructions for the computer application from a user, the set of instructions being in a format independent of a programming of the computer application;
interpret the set of instructions;
convert the set of instructions into a set of commands that are understood by the computer application; and
direct a behavior of the application based on the set of commands.

17. The program product of claim 16, the program product comprising an interface to the computer application, the set of instructions being received via a dialog wizard of the interface, and the set of instructions further being received pursuant to an interaction between the user and a facade of the interface.

18. The program product of claim 17, the facade comprising a 3-dimensional avatar, the interaction being between the user and the 3-dimensional avatar.

19. The program product of claim 17, the facade comprising a voice recognition program, the receiving comprising receiving the set of instructions verbally from the user.

20. The program product of claim 17, the facade comprising a set of natural language scripts, the receiving comprising receiving the set of instructions typographically from the user.

21. The program product of claim 16, the program product being created using a set of libraries.

22. The program product of claim 21, the set of libraries providing a mapping of instructions to behaviors of the computer application.

23. A system for masking changes to a computer application, comprising:
a module for receiving a set of instructions for the computer application from a user, the set of instructions being in a format independent of a programming of the computer application;
a module for interpreting the set of instruction;
a module for converting the set of instructions into a set of commands that are understood by the computer application; and
a module for directing a behavior of the application based on the set of commands.

24. The system of claim 23, the system comprising an interface to the computer application, the module for receiving the set of instructions comprising a dialog wizard of the interface, and the set of instructions further being received pursuant to an interaction between the user and a facade of the interface.

25. The system of claim 24, the facade comprising a 3-dimensional avatar, the interaction being between the user and the 3-dimensional avatar.

26. The system of claim 24, the facade comprising a voice recognition program, the receiving comprising receiving the set of instructions verbally from the user.

27. The system of claim 24, the facade comprising a set of natural language scripts, the receiving comprising receiving the set of instructions typographically from the user.

28. A method for deploying a system for masking changes to a computer application, comprising:
providing a computer infrastructure being configured to:
receive a set of instructions for the computer application from a user, the set of instructions being in a format independent of a programming of the computer application;
interpret the set of instructions;
convert the set of instructions into a set of commands that are understood by the computer application; and
direct a behavior of the application based on the set of commands.
